(19) United States
(12) Patent Application Publication
(10) Pub. No.: US 2003/0212959 A1
(43) Pub. Date: Nov. 13, 2003

(54) System and method for processing Web documents

(76) Inventors: Young Sik Lee, Kwanak-Gu (KR); Jong Cheon Park, Burlington, MA (US)

Correspondence Address: HOVEY WILLIAMS LLP, 2405 Grand, Suite 400, Kansas City, MO, 64108, US

(21) Appl. No.: 10/373,527

(22) Filed: Feb. 20, 2003

(30) Foreign Application Priority Data
May 9, 2002 (KR) 2002-25621

(51) Int. Cl. G06F 17/00

(52) U.S. Cl. 715/517; 715/513

(57) ABSTRACT

Disclosed herein is a system and method for processing Web documents. The Web document processing system includes a script, a database, a template and a processing engine. The script designates commands to indicate where the information of a Web document is fetched from, which part of the information of the Web document is valuable, and how the information of the Web document is extracted. The database stores the information of Web documents processed through the script. The template prescribes the output format of the information of Web documents stored in the database. The processing engine produces output results according to the output format prescribed by the template and outputting the output results.

Under the provisions of Section 119 of 35 U.S.C., Applicants hereby claim the benefit of the filing date of Republic of Korea Application No. PATENT-2002-0025621, filed May 9, 2002, which Application is hereby incorporated herein by reference.

### BACKGROUND OF THE INVENTION

1. Field of the Invention

The present invention relates generally to a system and method for processing Web documents, and more particularly to a system and method for processing Web documents, which is capable of processing the information of the Web documents provided via the Internet to create output results in a new form.

2. Description of the Prior Art

In general, information spread over the Internet is distributed by means of Web servers in the format of HyperText Markup Language (HTML) texts, and individuals access and use the information by means of Web browsers. For reference, the typical examples of such a Web browser are Internet Explorer produced by Microsoft and Netscape produced by Netscape Communications and now owned by America Online (AOL).

The information of the Web documents provided over the Internet is produced in a particular language suitable for a certain Web site, such as HTML, Extensible Markup Language (XML), Text (TXT), Wireless Markup Language (WML), etc., according to certain rules. Accordingly, the information of the Web documents cannot be read by users, and is limited in its output format when the information is processed to suit new formats of documents for information devices, such as Personal Digital Assistants (PDAs).

### SUMMARY OF THE INVENTION

Accordingly, the present invention has been made keeping in mind the above problems occurring in the prior art, and an object of the present invention is to provide a system and method for processing Web documents, which is capable of easily storing the information of the Web documents in a database while being easily arranged in the database according to rules, and representing resulting information in any required output format.

In order to accomplish the above object, the present invention provides a system for processing Web documents, comprising a script for designating commands to indicate where the information of a Web document is fetched from, which part of the information of the Web document is valuable, and how the information of the Web document is extracted; a database for storing the information of Web documents processed through the script; a template for prescribing the output format of the information of Web documents stored in the database; and a processing engine for producing output results according to the output format prescribed by the template and outputting the output results.

In addition, the present invention provides a method of processing Web documents, comprising the steps of a script processing information of Web documents provided over the Internet to desired information and storing the processed information in a database; a template prescribing an output format of the information of Web documents according to output results; and a processing engine processing the information of Web documents, whose output format is prescribed by the template, and outputting the processing results according to variables of the template.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram showing a system for processing Web documents in accordance with the present invention;

FIG. 2 is a flowchart showing a method of processing Web documents in accordance with the present invention;

FIG. 3 is a diagram showing the operation of the processing engine of FIG. 1;

FIG. 4 is a flowchart showing the operation of the processing engine when an HSC file is inputted to the processing engine; and

FIG. 5 is a flowchart showing the operation of the processing engine when a TPL file is inputted to the processing engine.

### DESCRIPTION OF THE PREFERRED EMBODIMENTS

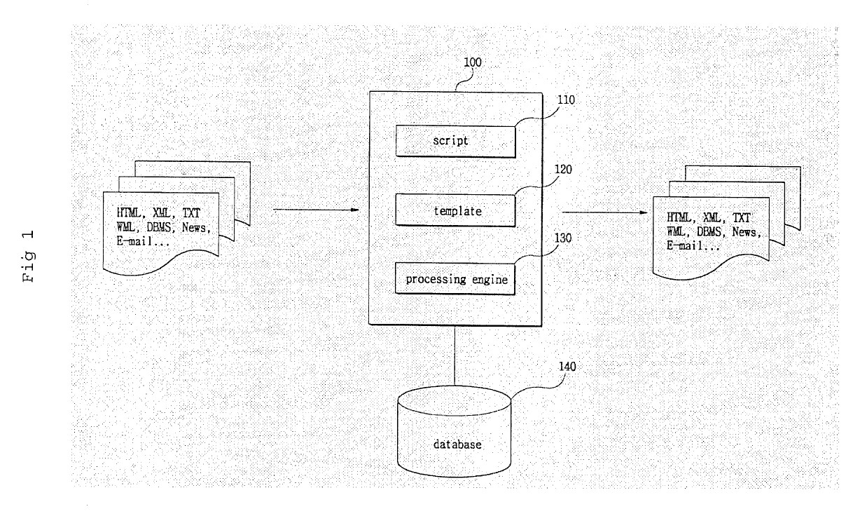

FIG. 1 is a view showing a system for processing Web documents in accordance with the present invention. The illustrated system is particularly well suited for processing electronic documents, which as used herein, is understood as a collection of data together forming an electronically transmittable integrated collection of c characters collectively including images or alphanumeric characters forming words as translated from electronic to human perceivable form. Such documents are transmitted preferably and typically via a global computer information network, e.g. the Web, however, the principles of the present invention are equally applicable to processing documents from virtually any type of network and are not limited to Web documents.

The Web document processing system 100 of the present invention, as shown in FIG. 1, is comprised of a script 110 for creating a program, that is, a collection of instructions, a template 120 for prescribing the format of output results, a processing engine 130 for producing output results by directly executing a program, and a database 140 for storing the information of Web documents processed through the script 110.

The script 110 designates commands to indicate where the information of a Web document is fetched from, which part of the information of the Web document is valuable, and how the information of the Web document is extracted.

In such a case, the script 110 includes an information attribute definition command for defining the attributes of the information of Web documents, a connection method definition command for defining a method for establishing connection to a server so as to fetch the information of Web documents, a classification definition command for classifying the information of Web documents into classes, an information extraction command for finding random information in a fetched source information file and processing the found information to desired information, a flow control command for repeating a command and storing processed information in a certain class during the processing of the information, and an object designation command for representing unexpected information on a certain information page.

The information attribute definition command is a command to define the attributes of information produced by the script 110, and includes ‘HSC_DOCUMENT’ and ‘HSC_PROPERTY’.

Additionally, when the script 110 is connected to a Web server (not shown) on the Internet to fetch information, connection to the Web server may be restricted because of a specific problem defined in the Web server. In such a case, commands provided as the connection method definition command include ‘HSC_CONNECTION’ and ‘HSC_LOGIN’.

The classification definition command allocates information fetched by a script command (referred to as a “HSC” hereinafter) to a class in which the information is stored and stores the information in the class. The classification definition command includes ‘HSC_CATALOG’ and ‘HSC_CATITEM’.

The information extraction command is a command to find random information in a fetched source file and process the found information to desired information. The information extraction command includes principal commands, such as a command to move a cursor so as to designate the starting point of work on the information file with a pointer, a command to change the source information file, and a command to represent a desired position while designating a range. The information extraction command includes ‘HSC_AREA’, ‘HSC_MISSION’, ‘HSC_TITLE, ‘HSC_CONTENT’, ‘HSC_BEGIN’, ‘HSC_END’, and ‘HSC_BASEURL’.

Meanwhile, the same flow control command can be used to extract a next article if a cursor command is created to fetch an article because information generally appears repeatedly in a news article of a Web page. The flow control command to repeat a command and store information in a certain class includes ‘HSC_LOOP’and ‘HSC_LIST’.

In the case where unexpected information is represented on a certain information page, for example, the source of an article is described and appropriately displayed on a screen, this information must be information with a source attribute and auxiliary information attached to a corresponding article. The object designation command includes ‘HSC_OBJECT’. Information is processed in such a way that ‘HSC_OBJECT’ allocates a name to each object and the template 120 provides a way to access information using the name.

The template 120 is provided as a tool for processing the information of Web documents to output results for users, and basically has a document format comprising template commands and character strings to be inputted to result documents.

Among markup commands used in the template 120 are ‘HSC_TEMPLATE’, ‘HSC_TPLPRINT’, ‘HSC_TPLFILE’, ‘HSC_TPLTRUE’, and ‘HSC_TPLFALSE’. In the case where the information of a Web document is stored in the database 140 through the processing of the script 110, there is provided a list of reserved words that represents the usage of variables used as indicators for representing the contents of the database 140.

In such a case, the command ‘HSC_TEMPLATE’ is a command to indicate the starting point of a template document, and has a version attribute as described in the following table 1. Whether a template document can be processed in the processing engine 130 is ascertained using attribute information.

TABLE 1

| Attribute | Description |
|---|---|
| Version | describe the version of a template file |

The command ‘HSC_TPLPRINT’ is used to represent information processed by the script 110, and is used in expressions that are produced using a variety of reserved words and attributes provided as described in table 2.

TABLE 2

| Attribute | Description |
|---|---|
| From | start value |
| To | end value |
| Step | variation value |
| counts | number of times |
| | (caution: can be used in the case |
| | where from, to and step are not |
| | used) |
| Name | name of variable |
| | (the name of a variable is |
| | described in the format enclosed |
| | with { } hereinafter) |

The command ‘HSC_TPLFILE’, as described in table 3, is stored in a file name in which the entire command up to a portion ending with </HSC_TPLFILE>is assigned to an attribute.

TABLE 3

| Attribute | Description |
|---|---|
| Name | elucidate file name |

The commands ‘HSC_TPLTRUE’ and ‘HSC_TPLFALSE’ are commands to control operations according to condition comparison as described in the following table 4.

TABLE 4

| Attribute | Description |
|---|---|
| | A reserved word that is a compared object is written as a |
| | condition. |
| Condition | If a corresponding reserved word is designated, a |
| | comparison result is ‘true’; if not, a comparison result |
| | is ‘false’. |

In the case where the information of Web documents stored in the database 140 is processed by the script 110, the list of reserved words represents the usage of variables used as designators. The following table 5 shows reserved words for such a purpose. The reserved words each start with an identifier “%%”. The kinds of the reserved words are described in table 5.

TABLE 5

| Reserved word | Description |
|---|---|
| % %document.name | script name of document |
| % %document.origin | source of script |
| % %document.url | url of script source |
| % %document.img | picture url representing script |
| % %document.date | Clipping date (English format) |
| % %document.kdate | Clipping date (Hangul format) |
| % %catalog.totalcount | number of classes used in script |
| % %catalog.{name}.title | class title corresponding to name |
| | Ex) % %catalog.c0.title |
| % %list.{name}.totalcount | number of articles in class |
| | corresponding to name |
| % %list.{name}.{digit}.title | name of digit-th article belonging to |
| | name class |
| | Ex) % %list.c0.0.title |
| % %list.{name}.{digit}.content | contents of digit-th article belonging to |
| | name class |
| % %list.{name}.{digit}.url | original document url of digit-th article |
| | belonging to name class |
| % %list.{name}.{digit}.object- | object-name portion of digit-th article |
| name | belonging to name class |

In such a case, for reference, in the case where {HSC filename} uses a single script, every reserved word has a format in which “%%(HSC filename}” representing the single script is basically omitted. In the case of a HSC using a multi-script, reserved words in which HSC file names are described, for example, %%{newhsc}.document.dat, are used.

TABLE 6

<HSC_TEMPLATE version=“1.0”>
<html>
<HSC_TPLPRINT>
<!--%%document.url-->
<head><title>%%document.name</title></head>
</HSC_TPLPRINT>
<body>
<a name=“list”></a>
<HSC_TPLPRINT>

<HSC_TPLTRUE condition=“%%document.docimg”>

%%document.docimg<br>
<font size=2>(%%document.date)</font><p>

</HSC_TPLTRUE>
<HSC_TPLFALSE condition=“%%document.docimg”>

<font size=3><b>%%document.name</b></font><br>
<font size=2>(%%document.date)</font><p>

</HSC_TPLFALSE>

</HSC_TPLPRINT>
. . .
<HSC_TPLPRINT counts=%%catalog.totalcount name=i>

<HSC_TPLPRINT counts=%%list.c{i}.totalcount name=j>
<HSC_TPLTRUE condition=“%%list.c{i}.{j }.content”>
<HSC_TPLFILE name=“A{i}-{j}.htm”>

<html>
<!--%%list.c{i}.{j}.url-->
<head><title>%%list.c{i}.{j}.title</title></head>
<body>
<h4>%%list.c{i}.{j}.title</h4>
<HSC_TPLTRUE condition=“%%list.c{i}.{j}.date”>

<font size=2>%%list.c{i}.{j}.date</font>

</HSC_TPLTRUE>
<HSC_TPLTRUE condition=“%%list.c{i}.{j}.writer”>

<br><font size=2>%%list.c{i}.{j}.writer</font>

</HSC_TPLTRUE>

<p>

<font size=2>%%list.c{i}.{j}.content</font>

</body>
</html>

<HSC TPLFILE>
</HSC TPLTRUE>
</HSC TPLPRINT>

</HSC TPLPRTNT>
</body>
</html>
</HSC TEMPLATE>

The table 6 shows an example of the template 120 that has a document format composed of template commands and character strings to be inserted into a resultant document. The commands of the script 110 and the template 120 are composed of tag markup language commands. The format of a markup command is as follows:

<tag name argument[=argument value]>character string</tag name>, or

<tag name argument[=argument value]>.

In the meantime, the processing engine 130 processes the information of Web documents to information in a format corresponding to that of output results prescribed by the template 120.

In such a case, an input to the processing engine 130 must be a HSC file in which script commands are defined or a template (referred to as a “TPL” hereinafter) file in which TPL commands are defined.

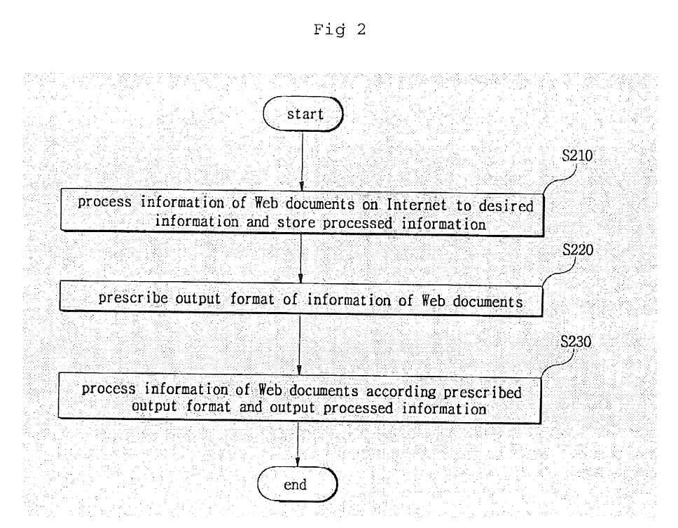

A method of processing Web documents using the Web document processing system constructed as described above is described with reference to FIG. 2.

First, the script 110 capable of producing a program, that is, a collection of instructions, fetches the information of Web documents provided through a variety of Web sites on the Internet, processes the information of Web documents to desired information using a variety of commands provided in the script 110, and stores the processed information to be arranged in the database 140 at step S210.

Thereafter, the template 120 prescribes the output format of the information of Web documents stored in the database 140 to correspond to that of output results at step S220.

At step S230, the processing engine 130 processes the information of Web documents to output results in the prescribed format by directly executing a program composed of the commands of the script 110 and the template 120 according to the variables of the template 120, and outputs the results.

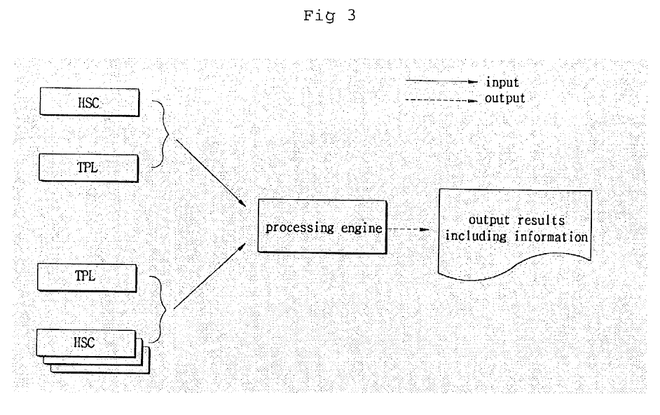

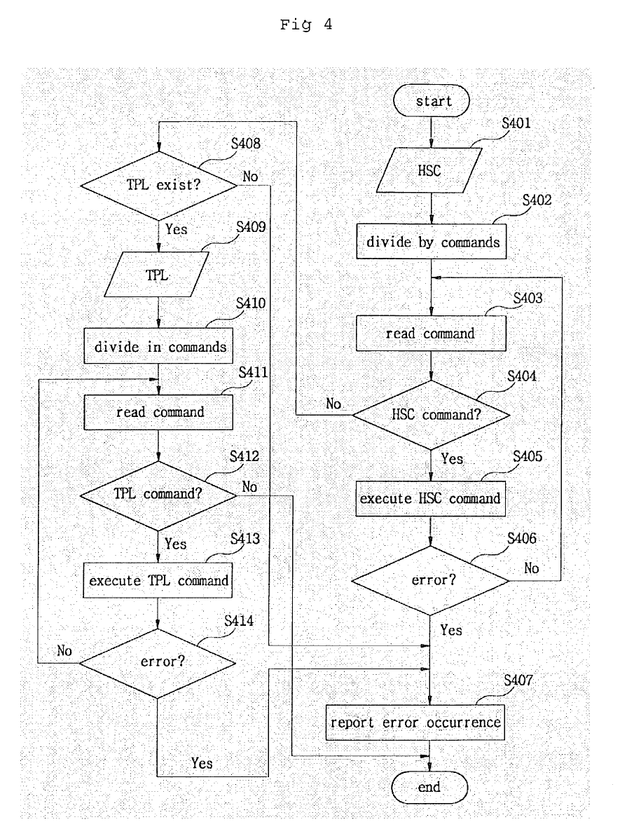

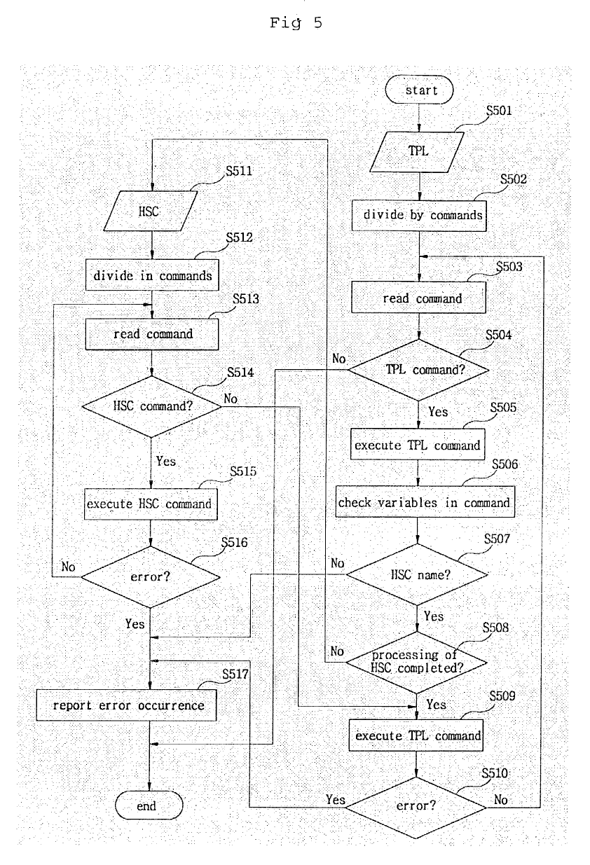

FIG. 3 is a view showing the operation of the processing engine of FIG. 1. FIG. 4 is a flowchart showing the operation of the processing engine in the case where the HSC file of FIG. 3 is inputted to the processing engine 130. FIG. 5 is a flowchart showing the operation of the processing engine in the case where the TPL file of FIG. 3 is inputted to the processing engine 130.

Referring to these drawings, in the case where the HSC file is inputted to the processing engine 130, output results are produced using the template defined in the HSC file as shown in FIG. 4.

The processing engine 130 receives the HSC file as an input and divides the inputted HSC file into command-level segments at steps S401 and 402. While any command is present, the process enters a loop in which an operation corresponding to each of the commands is carried out at steps S403 to S406. Thereafter, if the entire loop is terminated, it is determined whether TPL commands included in a result layout are represented in the HSC at step S408. If any TPL command is present, a corresponding TPL document is read and divided into TPL command-level fragments at steps S409 and S410. Thereafter, while any TPL command is present, results represented in a format corresponding to each TPL command are produced and the entire process is terminated at steps S411 to S414.

Referring to FIG. 5, if a TPL file is inputted to the processing engine 130, appropriate information is outputted according to the variables of the template 120 while processed results are stored in the database 130 after various script files are read and processed, in order to accomplish a corresponding template by means of a template using a multi-script. This process is described in more detail hereinafter.

The processing engine 130 receives the TPL file and divides the TPL file into TPL command-level fragments at steps S501 and 502. While any TPL command is present, the process enters a loop in which an operation corresponding to the command is carried out at steps S503 to S510. Subsequently, if a command to be processed in the above-described loop corresponds to a HSC name at step S507, a HSC file relating to a corresponding HSC name is read, its command loop is carried out, thereby producing information at steps S511 to S516. If all commands are executed and corresponding TPL results are achieved, the entire process is terminated at steps S507, S503 and S504.

As a result, the Web document processing system 100 can represent the information of Web documents, which is stored and arranged in the database 140, in any required output format, such as a HTML format, an XML format, a TXT format and a WML format.

As described above, the Web document processing system and method of the present invention provides the following effects.

First, the information of Web documents can be easily arranged in the database according to rules defined to be suitable for a certain Web site, and resulting information can be expressed in any required format.

Second, the commands of the script and the template are composed of tag markup language commands such as HTML commands, so general users can easily adapt to those commands and can directly create those commands, thus improving the efficiency of programming.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A system for processing electronic documents, comprising:
a script for designating commands to indicate from where document information associated with an electronic document is retrieved, which part of the document information is valuable, and how the document information is extracted from a particular document data source;
a database for storing the document information upon being processed through the script;
a template for prescribing an output format of the document information as stored in the database; and
a processing engine for producing output results according to the output format prescribed by the template and for outputting the output results.

2. The system according to claim 1, wherein the script comprises:
an information attribute definition command for defining attributes associated with the document information;
a connection method definition command for defining a method for establishing connection to a server so as to fetch document information;
a classification definition command for classifying the document information into information classes;
an information extraction command for finding particular information in a fetched source information file and processing the particular information into processed information corresponding to a specified format;
a flow control command for repeating a particular command and storing the processed information while classifying the processed information into a specified class during the processing of the processed information; and
an object designation command for representing unexpected information from a particular data source.

3. The system according to claim 1, wherein the template comprises:
a command HSC_TEMPLATE for indicating a starting point of a template document, the command HSC_TMPLATE having a version attribute;
a command HSC_TPLPRINT for creating an expression using various reserved words and attributes to represent output information produced by the script;
a command HSC_TPLFILE for indicating a template file name and storing information in a template file associated with the template file name designated as a template attribute;
a command HSC_TPLTRUE and a command HSC_TPLFALSE for controlling script operations according to a condition comparison; and
a list of reserved words for expressing usage of variables used as indicators to express contents of the database when the document information is stored in the database by the processing of the script.

4. A method of processing electronic documents, comprising the steps of:
using a processing engine to process document information provided over a network into processed information and storing the processed information in a database;
determining a processed output format of the document information based on the processed information;
processing the document information having a template output format as specified in a template; and
outputting the processed information according to variables associated with the template.

5. The method according to claim 4, wherein at the step of processing the document information, an input to the processing engine is an HSC file in which script commands are defined or the input to the processing engine is a TPL file in which template commands are defined.
